(19) United States
(12) Patent Application Publication
(10) Pub. No.: US 2006/0070082 A1
(43) Pub. Date: Mar. 30, 2006

(54) Managed object framework for network management application development

(76) Inventors: Manjula Sridhar, Lisle, IL (US); Edward G. Brunell, Chicago, IL (US); Martin S. Halkyard, Denville, NJ (US); Shankar Krishnamoorthy, Scotch Plains, NJ (US); Xiangyang Shen, Naperville, IL (US); Dong Zhao, Lisle, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,327

(22) Filed: Jun. 15, 2004

(51) Int. Cl. G06F 9/46

(52) U.S. Cl. 719/318

(57) ABSTRACT

Methods of developing an application program to manage a distributed system or network are provided. In one embodiment, the method includes: a) defining managed objects in a resource definition language and storing the definition in resource definition language files, b) parsing the resource definition language files to ensure conformity with the resource definition language and creating an intermediate representation of the distributed system, c) processing the intermediate representation to form programming language classes, database definition files, and script files, d) developing a reusable asset center framework to facilitate development of the application program, the reusable asset center including a managed object framework that provides management functionality to the application programs to support requests communicated to the distributed system from a network management station to manage the managed objects, and e) building the application program from the programming language classes, database definition files, script files, and the reusable asset framework.

### CROSS-REFERENCE TO RELATED APPLICATIONS

This application is related to Zhao et al., Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Zhao et al., Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Shen et al., Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to a reusable asset center (RAC) framework in a development environment for network management applications and, more particularly, to a managed object framework (MOF) within the RAC framework for providing the network management applications with a core framework for managing object representations associated with the network.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates an MOF within a RAC framework of a development environment for network management applications that resolves the above-referenced difficulties and others.

### SUMMARY OF THE INVENTION

A method of developing one or more application programs that cooperate to manage a distributed system comprising one or more servers is provided. At least one application program is associated with each server. In one aspect, the method includes: a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system, b) parsing the one or more resource definition language files to ensure conformity with the object-oriented resource definition language and creating an intermediate representation of the distributed system from the one or more conforming resource definition language files, c) processing the intermediate representation of the distributed system to form one or more programming language classes, one or more database definition files, and one or more script files, d) providing a reusable asset center framework to facilitate development of the one or more application programs, the reusable asset center including a managed object framework that provides management functionality to the one or more application programs to support requests communicated to the distributed system from a network management station to selectively manage the one or more managed objects, and e) building the one or more application programs from at least the one or more programming language classes, one or more database definition files, one or more script files, and the reusable asset framework.

A method of developing one or more application programs in operative communication to manage a network including one or more servers is provided. At least one application program is associated with each server. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network created in the parsing step includes a parse tree, c) processing the parse tree to form one or more programming language classes, wherein the one or more programming language classes formed include at least one of one or more system classes, one or more module classes, one or more managed object classes, and one or more composite attribute classes, d) providing a reusable asset center framework to facilitate development of the one or more application programs, the reusable asset center including a managed object framework that provides management functionality to the one or more application programs to support commands communicated to the distributed system from a network management station to selectively manage the one or more managed objects, and e) building the one or more application programs from at least the one or more programming language classes and the reusable asset framework.

A method of developing an application program to manage a network is provided. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network includes object meta-data, c) processing the object meta-data to form one or more programming language classes, one or more database definition files, and one or more script files, wherein the one or more programming language classes formed include at least one of an index class and a query class, d) providing a reusable asset center framework to facilitate development of the application program, the reusable asset center including a managed object framework that provides management functionality to the one or more application programs to support commands communicated to the distributed system from a network management station to manage the one or more managed objects, and e) building the application program from at least the one or more programming language classes, one or more database definition files, one or more script files, and the reusable asset framework.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a RAC development environment for development of network management applications using a managed object framework (MOF).

FIG. 10 is a block diagram of an embodiment of a typical MODL file of the RAC development environment.

FIG. 11 is a block diagram of an embodiment of the MOF.

FIG. 12 is a block diagram of an embodiment of resource classes of the MOF.

FIG. 13 is a block diagram of an embodiment of general purpose classes of the MOF.

FIG. 14 is a block diagram of an embodiment of utility classes associated with the MOF.

FIG. 15 is a block diagram of an embodiment of interface classes of the MOF.

FIG. 16 is a block diagram of an embodiment of attribute server interface classes associated with the interface classes of the MOF.

FIG. 17 is a block diagram of an embodiment of MOF notifier interface classes associated with the interface classes of the MOF.

FIG. 18 is a block diagram of an embodiment of name server interface classes associated with the interface classes of the MOF.

FIG. 19 is a block diagram of an embodiment of server map classes associated with the interface classes of the MOF.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

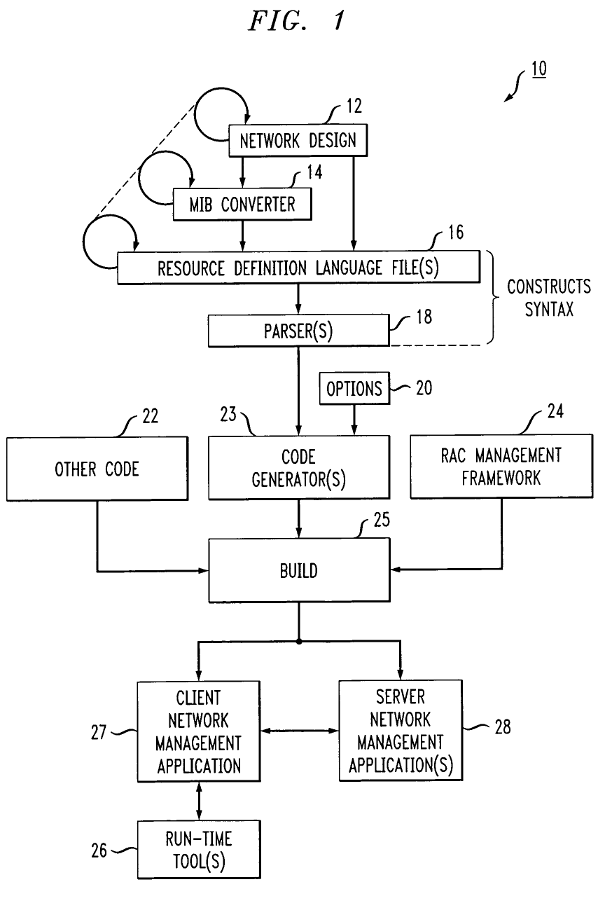

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

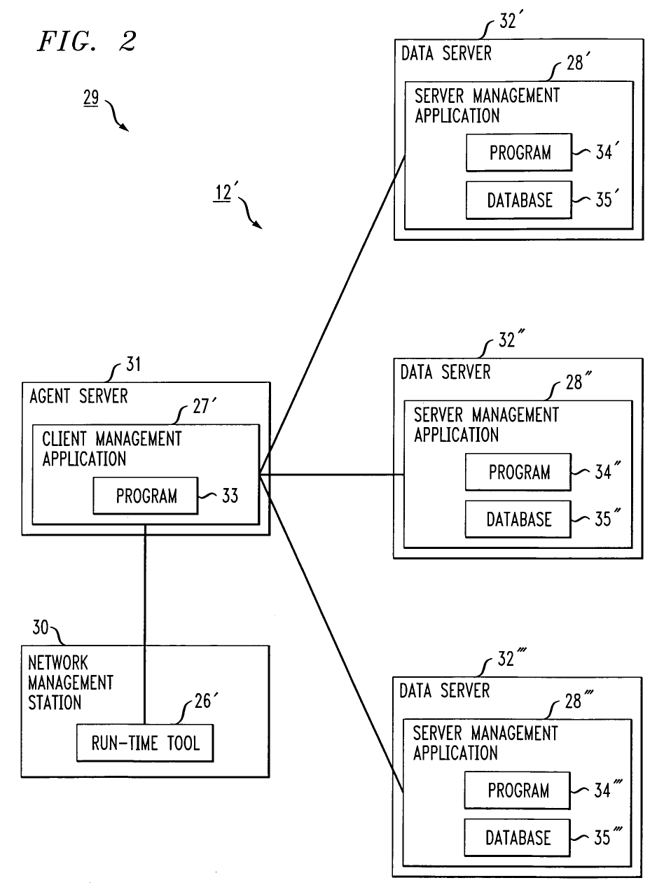

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28′″. The client network management application 27′ includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

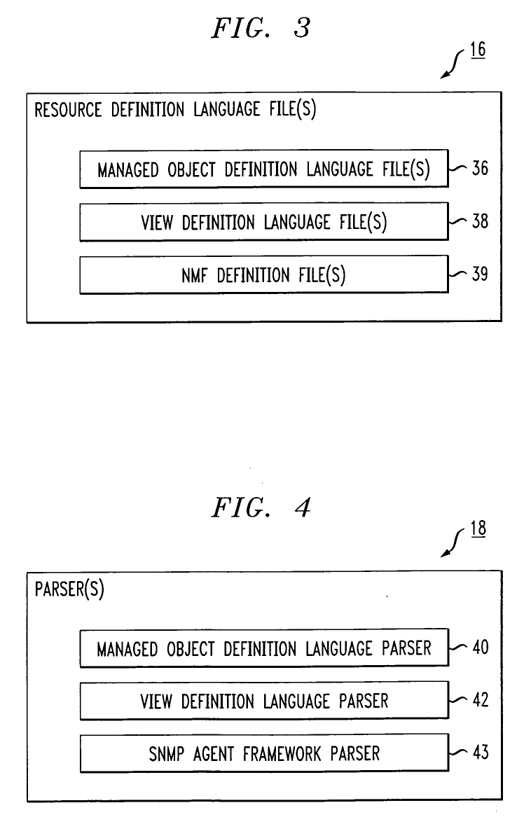

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

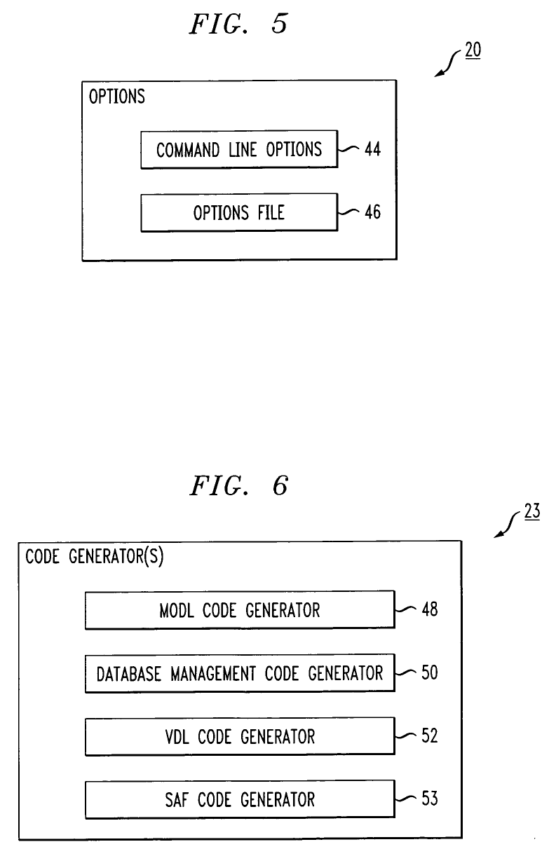

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

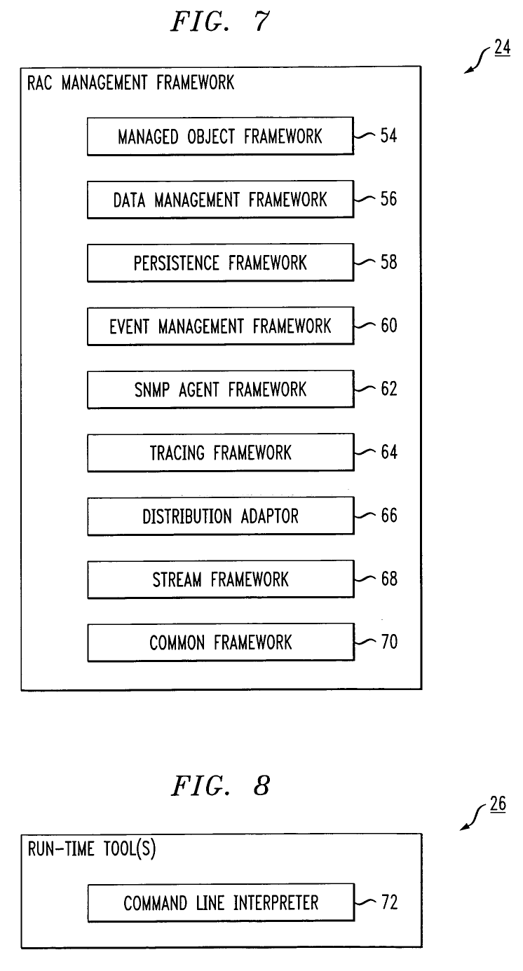

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

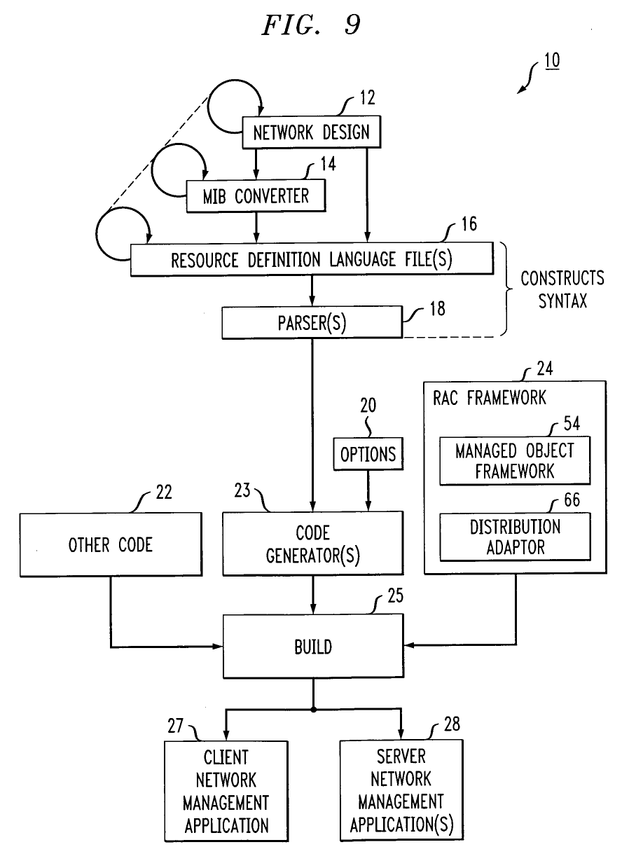

With reference to FIG. 9, the RAC development environment 10 shows that the build process 25 uses the MOF 54 and DA 66 to build the client and server network management applications 27, 28. The MOF 54 supports requests from the NMS 30 (FIG. 2) such as querying the value of a particular attribute, browsing managed objects, changing the value of attributes, creating and deleting managed objects, etc. Without the MOF 54, the developers would have to write stubs for data servers to communicate management information to the NMS via each communication protocol supported by the server. The MOF 54 effectively makes the management object protocol transparent to developers and users. The MOF 54 also browses the attributes automatically.

Part of the MOF 54 lies within the server address space (i.e., data server 32 (FIG. 2) where all the management information resides and part of the framework lies within the client address space (i.e., agent server 31 (FIG. 2)) where management services are accessed by the NMS 30 (FIG. 2). The MOF 54 provides the interface for accessing managed resources in a network element.

The MOF 54 provides classes to model and represent network resources. For example, managed object and managed object class tree classes provide a consistent way of storing and sorting network resources.

The MOF 54 provides interfaces for accessing the managed resources from remote applications, such as the NMS. The MOF 54 provides a uniform interface for the same types of functionalities. There is a set of base classes that provide the uniform interface and derived classes that implement those interfaces. The interface supports the following commands from a remote station: 1) create the managed object, 2) delete the managed object, 3) get attributes from the managed object, 4) set/modify attributes of the managed object, and 5) get bulk for the managed objects. The MOF 54 also provides utility classes to control the operations on the managed resources and proxy services to access managed object resources.

The MOF 54 is a framework for manipulating managed resources in a distributed network in a protocol independent way. The basic information model for the MOF uses a simplified GDMO-like scheme to define managed objects. The definitions of the managed objects are abstractions for resources that can be monitored or controlled by network management applications. A managed object instance (MOI) is an instance of a managed object class and is defined in terms of the attributes that it possesses. A MOI has its own value for each of the attributes defined in its managed object class, including a distinguished name which uniquely identifies the MOI. The set of all managed object classes constitutes the management information base (MIB) for the system or network.

The MOF 54 allows the network management applications to define, model, and distribute managed objects across various servers within the system or network. The MOF 54 supports requests from the NMS, including querying the value of a particular attribute, browsing the managed objects, changing the value of the attributes, creating and deleting the managed objects, etc. The MOF 54 also isolates specifics of network management protocols, such as SNMP or CMIP, from developers using the RAC development environment to develop network management applications.

The MOF 54 isolates the distribution of managed objects within the network management applications from the network management protocol agent by using a managed object name service. Even though the managed objects are distributed across various physical servers within the application, the generic agent transparently accesses the managed objects without having to know its specific location.

The basic architecture for a system or network implementing network management applications developed using the RAC development environment, including the MOF 54, is depicted in the run-time network management environment 29 of FIG. 2. As shown in FIG. 2, a typical system or network including management data that is distributed across various different data servers 32. These data servers could be in multiple hosts and in multiple processes. Typically, there is also an agent server 31 (as shown) that serves as a proxy for various management data. The NMS 30 typically contacts the agent server, which in turn contacts various data servers to retrieve the desired management data.

In general, the MOF includes the following features: 1) creation and deletion of managed object, 2) retrieval and browsing of attributes, 3) communication of actions, 4) notification of access to managed object, 5) identification of managed object hierarchy in managed object containment tree, 6) notification of change to managed object, 7) multi-thread safe access to managed object, 8) compatibility with legacy code, and 9) architectural neutrality.

Creation and deletion of managed objects on any given server within the network or system from the NMS is provided by the MOF. The standard creation and deletion are provided without the developer writing extra code for each type of managed object. If the developer wants to do something different from the standard or generic functionality, the MOF is extensible to customization. Retrieval and browsing of any combination of attributes from a given managed object instance in a single call is provided by the MOF. This feature also supports lexicographic browsing of the managed objects without the developer writing code for each type of managed object.

Through the communication of action feature, the MOF has the ability to carry an action that contains arbitrary input and output parameters associated with a managed object. The MOF will dispatch the action on the server that contains the specified managed object. The notification of access feature of the MOF provides optional callbacks whenever a given attribute or managed object is accessed or modified.

Through the managed object containment tree feature, the MOF provides the application program interface (API) for the network management application to retrieve the hierarchy of various managed objects in the system or network. This may be provided as a static containment tree at the class level or as a dynamic containment tree at the instance level. The notification of change feature of the MOF provides the ability to push changes to any managed object, such as modification, creation, deletion, and action, to other servers associated with the network management application.

Through the multi-thread safe feature, the MOF provides access to managed objects within a given data server that is multi-thread safe. The legacy code compatibility feature of the MOF provides a bridge between the MOF and previously existing application code that does not use the MOF. The MOF code resides in the data server address space and co-exists with the application code. The MOF code represents legacy code data associated with the data server as managed objects and retrieves and modifies the legacy code data in a minimally intrusive way. The neutral architectural feature of the MOF provides a common interface irrespective of various underlying transport protocols, ORB implementations, local calls, etc.

In MOF, a managed object class can be identified either by its class name or by its hierarchy in the class containment tree. Two terms used in conjunction with the RAC development environment are managed object class name and distinguished name hierarchy name. The managed object class name is an identifier that uniquely identifies the managed object class, e.g., “Bts”. The distinguished name hierarchy name is the position of the managed object in the containment tree. The distinguished name hierarchy name includes a sequence of unique node names from the root to the node at which the managed object is positioned. For example, if a managed object “Bts” is identified by a node “BtsId” that, in turn, is a child of a node “BscId” and “BscId” is a child of the root, the distinguished name hierarchy name of class Bts is “BscId.BtsId”. Within the RAC development environment, the APIs may use the managed object class name and/or the distinguished name hierarchy name. The RAC framework provides a way to convert from one to the other to facilitate various usages by the APIs.

The MOF supports the following commands associated with management operations from the NMS: 1) get, 2) getfirst, 3) getnext, 4) set, 5) create, 6) delete, 7) action, 8) scope/bulk get, and 9) processmofcommandlist. Each command, except the processmofcommandlist command, operates on one managed object instance. When the network management application needs to operate on multiple managed object instances, the developer prepares code that issues multiple commands with respect to the commands operating on individual managed object instances.

The “get” command retrieves attributes of a managed object instance. The “getfirst” command retrieves attributes from the first lexicographically positioned managed object instance for a given distinguished name hierarchy. The “getnext” command retrieves attributes from the next lexicographically positioned managed object instance to the distinguished name passed as an input parameter to this command. The “set” command modifies attributes of a managed object instance. The “create” command creates a managed object instance for the distinguished name passed as the input parameter. The network management application may ignore the input distinguished name and assign a different distinguished name to the created managed object. The “create” command returns the distinguished name of the created managed object. The “delete” command deletes the given managed object instance identified by the distinguished name passed as an input parameter. The “action” command performs the action on a given managed object. The “action” command has set of input parameters and output parameters. Typically, the “action” command is handled by the application callbacks. The “action” command may also be visualized like IDL operations on interfaces. The “scope/bulk get” command retrieves multiple managed object instances. The “processmofcommandlist” command performs multiple set/create/delete operations as a single atomic operation.

The MOF supports the following types of attributes: 1) value based, 2) reference based, and 3) function based. Value based attributes are attributes that directly contain a value. Reference based attributes are attributes that reference some physical memory location that contains the actual value of the attribute. When the memory location is modified, the attribute value is also modified. Function based attributes are attributes in which the value is a managed object by some other class called implementation class.

The function based attribute contains the get and set methods to retrieve the value from the implementation class. The get and set request is simply forwarded to the implementation class and the attribute does not contain the value of the attribute. Using the existing class can be adapted to the MOF by providing its methods. With this approach, the implementation class need not be aware of the RAC framework. This is achieved using C++ member function pointers.

The MOF also supports the concept of managed object distribution by which a given managed object can be implemented in multiple physical processes. To provide this, the MOF defines the concepts of interface managed object and implementation managed object. The interface managed object defines the managed object that is used by external entities, such as the NMS, to access the network element data. In the RAC framework, the managed object class is used to implement managed objects. The managed object class is not distributed and hence has to be implemented in a single process. In order to extend the managed object class to multiple processes in the RAC framework, a given interface managed object may be implemented by multiple implementation managed objects. Developers can define the interface and implementation details of the managed object in the MODL files. The RAC framework has the ability to convert the MOF request meant for a given managed object instance to multiple MOF requests based on the implementation managed object instances.

With reference to FIG. 10, an embodiment of a typical MODL file 36 includes a module(s) 73, attribute type definitions 74, enum type definitions 75, class(es) 76, and attribute(s) 77. MODL is used to define the managed resources. MODL allows for definition of managed resources as managed object classes. Thus, a class 76 corresponds to a managed resource. Each managed resource can have one or more managed objects. An attribute 77 corresponds to a managed object. MODL consists of constructs to organize the data models in a set of MODL file(s) 36. This facilitates easy readability and provides a mechanism for abstracting the managed resources and objects in the network design. A typical MODL file, for example, includes a .odl extension and is structured as follows:

```
Module <module name>
{
//Attribute type definitions
//Enum type definitions
Class <<classname>>
    {
        index {
Attribute1 ...
Attributen.
            }
            Attribute attr1;
            Attribute attr2;
            Attribute attr3;
    }
}
```

MODL includes a number of reserved keywords. For example, the reserved keywords may include module, Class, AttributeType, index, const, Valid, readonly, extends, implements, enum, action, in, and out. The table below provides the general meaning for each MODL keyword:

| KEYWORD | MEANING |
|---|---|
| module | Used for module. |
| Class | Used to specify a managed object. |
| AttributeType | Used to specify composite attribute (user defined data |
| | type, similar to structures) |
| index | Used to specify the index of a managed object. |
| const | Used to specify the constness of a data member |
| | (Attribute) |
| Valid | Used for RANGE specifications. |
| readonly | Used to specify readonly attribute types. |
| extends | Used to denote inheritance. |
| implements | Used to specify the implementation. |
| enum | Used for enum types. |
| action | Used to specify methods of an managed object. |
| in | Used to denote input parameter of an action. |
| out | Used to denote output parameter of an action. |

The module 73 is the highest level of abstraction in MODL and is analogous to a C++ name space. Modules 73 are used to logically group the MODL types, such as enum, attribute types, managed objects, and other module declarations. A module declaration is not restricted to a single physical file (i.e., developers can add definitions to a module from several module declarations in the same or different MODL files. The syntax for a module declarations is as follows:

```
module <<modulename>> {
    (EnumDeclaration|AttributeTypeDeclaration|
      ClassDeclaration|ModuleDeclaration)
};
```

As shown in the syntax, a module 73 may consist of one or more enum declarations, managed object declarations, attribute type declarations, or other module declarations. A module 73 can access data types in other modules by appending <<modulename>> with the qualifier (“.”) and the name of the data type. For example, module X can access enum YY in module Y as shown below:

```
module X {
    enum XX ...
    module Y {
      enum YY ...
    };
};
```

The enum “XX” in module “X” can be accessed from another module as “X.XX.” Similarly, enum “YY” in module “X” can be accessed from another module as “X.Y.YY.” The types can also be accessed relatively. For example, within the module “X”, type “XX” can be accessed as “XX” and type “YY” can be accessed as “Y.YY”. An implicit module, referred to as root module, contains all the type declaration in an MODL file that are not under any module. The root module also contains all the top-level module declarations.

Class 76 is the unit of abstraction in MODL that is available at the interfaces for access. All MOF operations are operated on managed object class. The class specification of a managed object class contains the name of the class, any special property of the managed object, the index specification, and the attribute declaration. The syntax for a class specification is as follows:

```
class <<managed object class name>> {
    [(ImplementsDeclaration [ExtendsDeclaration]) |
      (ExtendsDeclaration [ImplementsDeclaration])]
    <Index Declaration>
    (<Attribute Declaration>)*
    (<Action Declaration>)*
};
```

An example of a class declaration is as shown below. In the example, the class name is OverloadControlSec. The class belongs to a group named Bts.Sector. The group specification is optional. If no group is specified, then root group is assumed. The group specification is used to hierarchically group the managed objects.

```
class OverloadControlSec
{ # class name specification
  group Bts.Sector; # optional group specification
  index
{ # index of the managed object specification
    const Integer BscCfg = 1; # attributes can have a
default value.
    Integer BtsCfg;
    Integer SectorCfg;
    const Integer OverloadControlSec = 1;
      };
  # attributes specification
  Integer FpcPilotGain;
  IpAddress BtsIpAddress;
  DisplayString Version;
  PersonalityType Personality;
};
```

Classes 76 in a module 73 can have various relationships, such as implementation of another managed object (implements declaration), inheritance of attributes of another managed object (extends declaration), combinations of implementation and inheritance, and parent-child relationships (index).

An implements declaration is provided by the implements keyword and specifies that the given managed object is an implementation of another managed object. The syntax for an implements declaration is as shown below. FullyQualifiedName is the name of the managed object optionally qualified by its module name.

implements <<FullyQualifiedName>>

A given managed object can be the implementation of one other managed object. An example of an implementation specification is provided below. In this example, the interface managed object Bts has been implemented by two managed objects—BtsCfg and BtsDynamic. It should be noted that the Bts managed object does not physically exist in the given network element. Bts provides an external interface and acts as proxy. On receiving this request, the MOF agent server automatically redirects these requests to data servers containing the implementation managed objects. BtsCfg and BtsDynamic managed objects may not be known to NMS, since they represent how a given managed object is split into multiple managed objects because of implementation constraints.

```
class Bts {
    index {
        const Integer Bsc = 1;
        Integer Bts;
    };
    DisplayString Descr;
    NeType Type;
    UnsignedInteger Uptime;
    DisplayString Name;
    DisplayString Contact;
    DisplayString Location;
    Rac.AlarmSeverityType AlarmLevel;
    ConnInitCommandType InitCommand;
    Rac.AdministrativeStateType AdminState;
    Rac.OperationalStateType OpState;
    Rac.UsageStateType UsageState;
};
class BtsCfg implements Bts {
    index {
        const Integer Bsc = 1;
        Integer BtsCfg;
    };
    DisplayString Descr;
    NeType Type;
    UnsignedInteger Uptime;
    DisplayString Name;
    DisplayString Contact;
    DisplayString Location;
};
class BtsDynamic implements Bts {
    index {
        const Integer Bsc = 1;
        Integer BtsDynamic;
    };
    NeType Type;
    Rac.AlarmSeverityType AlarmLevel;
    ConnInitCommandType InitCommand;
    Rac.AdministrativeStateType AdminState;
    Rac.OperationalStateType OpState;
    Rac.UsageStateType UsageState;
};
```

Once a managed object implements a given managed object X, then X will only be an interface managed object and there cannot be any other implementation of X. So all the attributes of X will have to be implemented by some managed object. Consider the following exemplary implements specification:

```
class X {
    Integer A;
    Integer B;
};
class Y implements X {
    Integer A;
};
```

In the exemplary case, the attribute “B” is not implemented by any managed object. Since “Y” implements “X,” there cannot be an implementation of X. At this point, whenever the NMS requests attribute “B” of class “X” there is no managed object that implements attribute “B.” If this poses a problem, one solution is to introduce another managed object “Z” having the following implements declaration:

class Z implements X {
Integer B;
};

A given managed can inherit all the attributes of another managed object through an extends declaration which is implemented using the extends keyword. The syntax for an extends declaration is shown below. FullyQualifiedName is the name of the managed object optionally qualified by its module name.

extends <<FullyQualifiedName>>

A given managed object can be inherited by one other managed object. The inheritance specification is introduced in MODL to reuse existing managed object implementations. It is assumed a common information model is already available for other network elements. Once available, managed objects can be specified in another MODL file, implementation of the managed object can be generated and modified by the developers, and a library of managed object implementations are made available. An example of a managed object inheriting from another managed object through an extends specification is provided below. In this example the NetworkElement managed object inherits the attributes of Tmn managed object. Bsc inherits the attributes of NetworkElement, thus inheriting the attribute of Tmn as well. Bsc is extended from NetworkElement to specify the proper containment hierarchy.

```
  class Tmn {
    AdministrativeStateType AdminState;
    OperationalStateType OpState;
    UsageStateType UsageState;
};
class NetworkElement extends Tmn {
    index {
        const Integer Rac = 1;
        const Integer NetworkElementId = 1;
    };
    DisplayString Descr;
    NeType Type;
    UnsignedInteger Uptime;
    DisplayString Name;
    DisplayString Contact;
    DisplayString Location;
    AlarmSeverityType AlarmLevel;
    ConnInitCommandType InitCommand;
};
class Bsc extends NetworkElement {
    index {
        const Integer Bsc = 1;
    };
};
```

In MODL the index declaration specifies where the managed object will be contained in the management containment tree. However, using the extend specification, the Bsc class can inherit attributes from another managed object in the containment tree. The distinguished name of the inherited base class is ignored and the most derived class distinguished name is used to identify the hierarchy of the managed object in the containment tree.

The inheritance and implementation combination is bit more complicated. In this type of relationship, the implementation declaration is specified for the most derived class. If there is an implements declaration for the base class, it will be ignored by the derived class. An exemplary implements and extends combination is provided below. In this example, the attributes Type and Name are contained by the BscStatic managed object. The BscDynamic managed object contains the rest of the attribute. The Bsc will ignore any implements declaration that is specified on the NetworkElement.

```
    class Bsc extends Wireless.NetworkElement {
        index {
            const Integer Bsc = 1;
        };
    };
    class BscStatic implements Bsc{
        index {
            const Integer BscStatic = 1;
        };
        Wireless.NeType Type;
        DisplayString Name;
    };
    class BscDynamic implements Bsc extends
Wireless.NetworkElement{
        index {
            const Integer BscDynamic = 1;
        };
    };
```

Parent-child relationships are a type of containment relationship. In MODL, an index declaration is used to determine if a class is a parent or child of another class. The index declaration is implemented using the index keyword. An example of an index declaration showing a parent-child relationship is shown below. Class C is considered a child of Class A because Class C's index contains Class A's index parameters and additional index parameters.

```
Class C {
              index {
                  Integer indexA;
                  Integer indexC;
                      }
            Integer attrc;
        }
```

Parent-child relationships determine the order of storing, accessing, and retrieving the managed objects. Multiple containment is not available (i.e., a child cannot have two parents at the same level). However, multiple levels of containment are available (e.g., Class C can have a child and this child is also considered a child of A). Parent-child relations such as these form the tree structure for the network design.

The index declaration may also declare the index of a corresponding managed object through a list of attribute declarations. The numbers of the attributes contained in the index declaration determine the position/level of the managed object in the containment tree. The syntax for an index declaration is as shown below.

index {
(<Attribute Declaration > + )
};

An example of an index declarations is provided below:

```
index {
    const Integer BscCfg = 1;
    Integer BtsCfg;
    Integer FrameCfg;
};
```

The index declaration is used to uniquely identify an object throughout the system, hence an index declaration is unique throughout the MODL files. Index is also used to define parent-child relationships, as described with regard to containment relationships.

Each managed object class 76 includes one or more managed objects identified by an attribute declaration. The syntax for an attribute declaration is as shown below. The type is the type of the attribute. The name is the name of the attribute. The size is optional and specifies the size of the attribute. The type will be either a fully qualified type or relative to the given module. In the case of a DisplayString, for example, the size can be used to specify the size of the string. If const precedes the attribute, the attribute is considered to have a constant value. The const declaration will be used for index declarations. If readonly precedes the attribute, the attribute cannot be modified by the NMS. Valid values for the attribute may be specified, but are optional.

```
[const][readonly] <AttributeType>[size]
  <<Attribute Name>> [=<<default value>>]
  [valid <<values>>];
```

Some additional examples of attribute declarations are provided below. In the first example, an attribute is declared for an Integer A with no default value. In this example, a default value of 0 is assumed. In the second example, an attribute is declared for an integer B with a default value of 10. In the third example, an attribute is declared for an integer C with a default 100 and valid values from 50 to 150. In the fourth example, an attribute is declared for a 32-bit display string D with an initialize value of “YY.” In the fifth example, an attribute is declared for a variable whose type is enum and initialize with the symbolic constant value “enabled.” The sixth example shows the use of a qualified type.
Integer A;
Integer B=10;
Integer C=100 valid {50-150}.
DisplayString(32) D=“YY”;
OperationalState OpState=enabled;
Rac.AdministrativeStateType AdminState=unlocked;

An action declaration may be specified for a given managed object class in MODL. The action specification occurs under the class specification. An action specification is identified by name and contains input and output parameters. The action name is unique within the given class. The syntax for an action declaration is as shown below. An output parameter can be used as a return parameter by the application.

action <<action name>> (((in <<input parameter>>) +)|
((out <<output parameter>>) +) * )

Some examples of action declarations are provided below:

```
    action lockBts( in Integer btsId, out Integer Result
);
    action action1( in Integer param1, in IpAddress
param2, out DisplayString param3);
```

Built-in attributes are attribute types that MODL provides to developers. The following built-in attribute types are provided by MODL:
Int, Int32, and Integer represent the attribute type “Integer” (Integer is equivalent to C++ Integer and is mapped to IntegerAttribute in the RAC management framework);
Uint, Uint32, and UnsignedInteger represent the attribute type “UnsignedInteger” (UnsignedInteger is equivalent to unsigned int in C++ and maps accordingly);
Int64 and DoubleInteger represent the attribute type “DoubleInteger”;
Float represents the attribute type “Float”;
Double represents the attribute type “double”;
String and DisplayString represent the attribute type “DisplayString”;
IpAddr and IpAddress represent the attribute type “IpAddress”;
Moid and DistinguishedName represent the attribute type “DistinguishedName”;
Octet and OctetString represent the attribute type “OctetString”; and
Sequence represents the attribute type “Sequence.”

Sometimes the built-in attribute types are not sufficient to describe a managed resource. If so, developers use the AttributeType keyword to declare additional attribute types (i.e., composite attributes). The syntax for a composite attribute declaration is provided below. <Attribute Type Name> is the type name of the composite attribute.

AttributeType <<Attribute Type Name>> {
[(<Attribute Declaration >) + ]
};

Some examples of attribute declarations are provided below. In the first example, an attribute type IpAddress is introduced. Since this is not a built-in attribute type, this is a composite attribute. Since the contents of IpAddress are not declared, during compilation the compiler will not know its contents. In the second example, another composite attribute type ConnectionId is introduced and its contents are properly declared. During compilation, the compiler will know the contents of ConnectionId.

```
AttributeType IpAddress;
AttributeType ConnectionId {
    Integer Id;
    DisplayString(32) src;
    DisplayString(32) Dest;
};
```

Attribute properties provide additional descriptions for attributes apart from the name and types in MODL. The properties provide information such as default values, constraints on the values (e.g., valid ranges), and accessibility options. Attribute properties are applied both to built in and composite attribute types.

The default values for an attribute can be specified in MODL within the attribute declaration. In other words, the default values are set during managed object instantiation as part of constructor. The default values are specified using “=” construct when declaring the attribute. Several examples of an attribute declaration that specifies a default value are provided below:

Integer aInt=100;

DisplayString text=“Hello”;

The constraints on the values, such as a valid range, of an attribute can be declared in MODL using the Valid keyword. The syntax for a Valid declaration is as shown below. The Constant is the constant value of the attribute.

Valid {(Constant | (Constant−Constant) (,) ?) + };

Examples of Valid declarations are provided below. In the first example, the valid range of the integer A is from 1 to 10. In the second example, the valid range of the integer B is from 1 to 20, excluding 11. In the third example, valid values of NetworkElementId include Bsc, Sdn, Msc, and Bts. In the fourth example, the valid range for a Sequence type is from 1 to 100. This implies all the elements of Sequence are between 1 and 100, inclusive.

Integer A Valid {1-10};
Integer B Valid {1-10, 12-20};
DisplayString(10) NetworkElementId Valid {“Bsc”, “Sdu”,
“Msc”, “Bts”} = “Sdu”;
Sequence<int, 4> Valid {1-100};

Accessibility to attributes can be established using, for example, the readonly or const keywords. The readonly keyword is used to specify an attribute as a read-only attribute. When defined as readonly, no set operation is done on this attribute. The const keyword permits a set operation if the set value is equal to the const value.

An enum declaration is implemented in MODL using the enum keyword and provides a valid range of values for the attributes, as well as some meaningful symbolic constant when presenting the contents. By default, the constants start at 0, but another value can be assigned. Examples of enum declarations are provided below:

```
enum OperationalState {
    enabled,
    disabled
};
enum PersonalityType {
  noPersonality = 0,
  pilotSyncAccess = 1,
  psaPaging = 2,
};
```

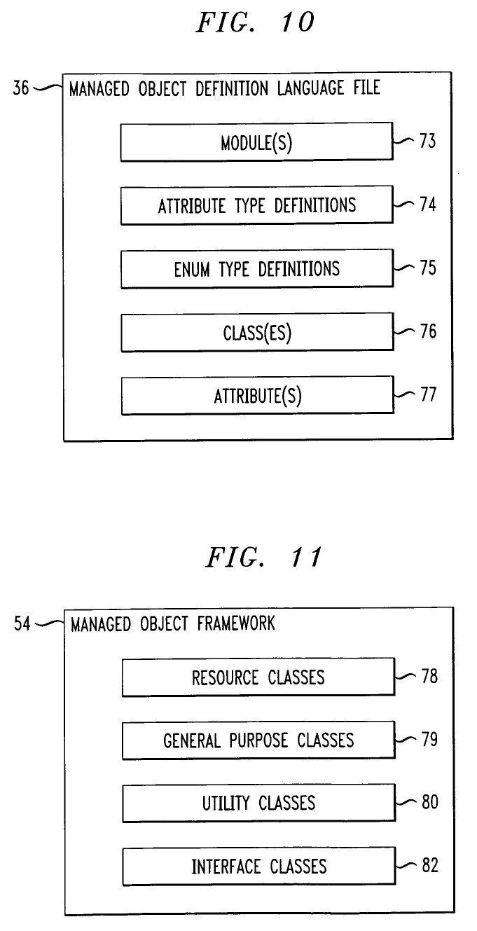

With reference to FIG. 11, the MOF 54 includes resource classes 78, general purpose classes 79, utility classes 80, and interface classes 82. The keywords defined in MODL map to classes in the MOF 54.

With reference to FIG. 12, the resource classes 78 include a managed object class 84, an attribute class 86, a distinguished name class 88, a managed object class list class 90, an attribute factory class 92, an attribute list class 94, an attribute iterator class 96, an action def class 98, a managed object def class 100, an attribute event handler class 102, an attribute event handlers list class 104, a containment tree node class 106, and a managed object containment tree class 108.

All the resources in a network element are represented as managed objects. The managed object class 84 represents the managed objects that are defined in the MODL files. A subclass of the managed object class 84 is generated for each class defined in the MODL files. The instances of the managed objects are objects of the managed object class 84. The managed objects include a list of attributes that are managed. Each managed object also includes a distinguished name that is unique for each managed object within the system or network. The distinguished name maps to the index keyword of the MODL files.

Subclasses of the attribute class 86 map to the variables of the classes declared in the MODL files. Each derived attribute class knows how to externalize its state onto an object stream and how to internalize its state from the object stream. The MOF has a predefined set of attributes as described below. The available subclasses in the RAC framework serve two purposes. First, one set of the attribute classes serve as generic classes that map to the MODL type. These generic classes include: a display string attribute (String) class, a distinguished name attribute (moid, dn) class, a double attribute (double) class, a double integer attribute (double integer) class, an enum base attribute (enum) class, a float attribute (float) class, an integer attribute (int, int32, int64, integer) class, an IP address attribute (IpAddress) class, an octet string attribute (OctetString) class, a scalar attribute (template base class for float and double) class, a sequence attribute (sequence) class, and an unsigned integer attribute (unsigned int) class. Another set of attribute classes are related to TMN state management. Developers can use these specific classes to provide state management capabilities. These specific classes include: an administrative state attribute class, an availability status attribute class, a conn attribute class, a conn init command attribute class, a control status attribute class, an Ne attribute class, an Ne init command attribute class, an operational state attribute class, an alarm attribute class, an alarm severity attribute class, and an alarm status attribute class.

Each managed object must have an index in order to be accessible from the outside world. The distinguished name class 88 represents the index. The distinguished name class 88 follows TMN in terms of identifier. The index is qualified as Type.Name.Value, which provide a unique identifier for a particular class of managed objects.

For each server there is a singleton managed object class list class 90 that contains the list of managed objects for that server. Within the managed object class list class 90, managed objects are ordered in a lexicographic fashion. This facilitates lexicographic browsing of the attributes from outside, especially via the SNMP transport protocol.

The attribute factory class 92 is used to create attributes. An attribute factory finder returns a corresponding attribute instance if the managed object name and the attribute name are known. An attribute type factory finder returns the attribute factory based on the type of attribute, for example, “Integer.” For each type of the attribute, corresponding attribute factory classes 92 are defined and instantiated. This facilitates parsing and interpreting data across interfaces.

The attribute list class 94 is a utility class within the resource classes 78 to hold a list of attributes. This class is used extensively across the RAC frameworks for storing and transporting groups of attributes.

The attribute iterator class 96 is used to iterate the attribute list. This is mainly used in the multi-threaded environment where multiple iterators may iterate over a single list.

The action def class 98 represents an action associated with a managed object. An action includes an action name, a set of input parameters, a set of output parameters, and result parameters.

The managed object def class 100 represents the managed object class. This class contains the schema information for any managed object class. For a given managed object class, the managed object def class 100 contains information such as base classes of the managed object class, any managed object that implements the given managed object, whether it is mandatory or not, and the module in which the given managed object class is defined. Initially, the managed object classes are identified in the MOF using their distinguished name class name. Thus, the position of the managed object is initially statically determined in the MOF. In the MODL files, each managed object is assigned a unique fully qualified name. The fully qualified name scheme is more flexible. The managed object def class 100 supports both naming schemes. A managed object def list provides a list of all managed objects in the system or network.

The attribute event handler class 102, in conjunction with the attribute event handler list class 104, provides application control while processing requests on particular attribute. The attribute event handler class 102 is an abstract base class and all the event handlers derive from this class and are registered with the singleton attribute event handler list class 104. The attribute event handler class 102 is used to handle events relating to attributes. The attribute event handler class 102 handles the events before the attribute is being read, before the attribute is being written, and after the attribute is written. In case of an error, all the handler functions return −1, otherwise the functions return 0. The attribute event handler list class 104 is used to register the attribute event handlers for a unique managed object and attribute name pair. A global instance of the attribute event handler list of this class is used to register the handlers.

The containment tree node class 106 represents the node of the containment tree of the various managed object instances in the system or network. This class helps the application to create and navigate the containment hierarchy.

The managed object containment tree class 108 represents the static containment tree of the various managed objects in the system or network. This class helps the application to create and navigate the containment hierarchy. Do not confuse this class with the instance based containment tree.

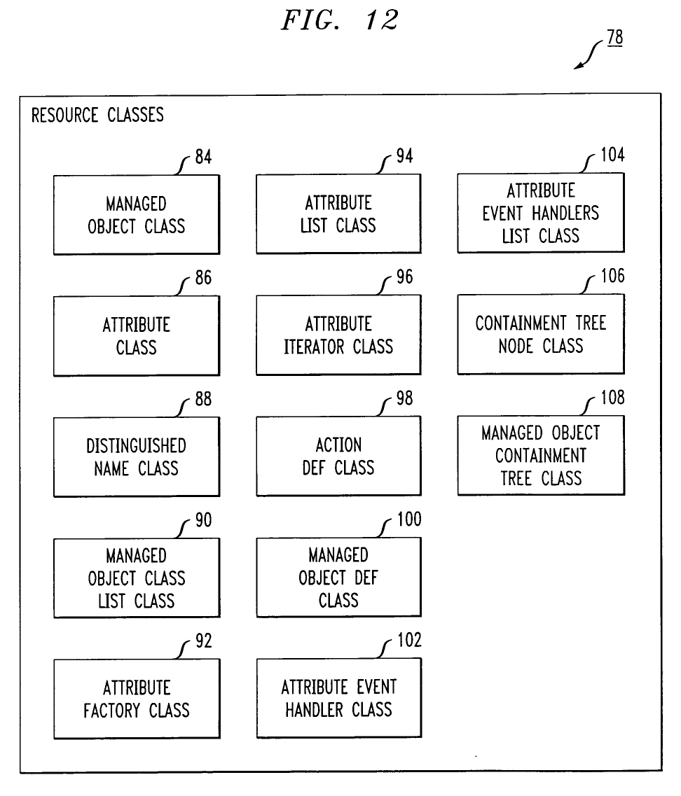

With reference to FIG. 13, the general purpose classes 79 include a connection managed object class 110, a connection class 112, a TCP connection class 114, a network element class 116, a network element managed object class 118, a TMN managed object class 120, and a TMN resource class 122. These classes correspond to general purpose managed objects. These implementation classes are distributed along with the MOF.

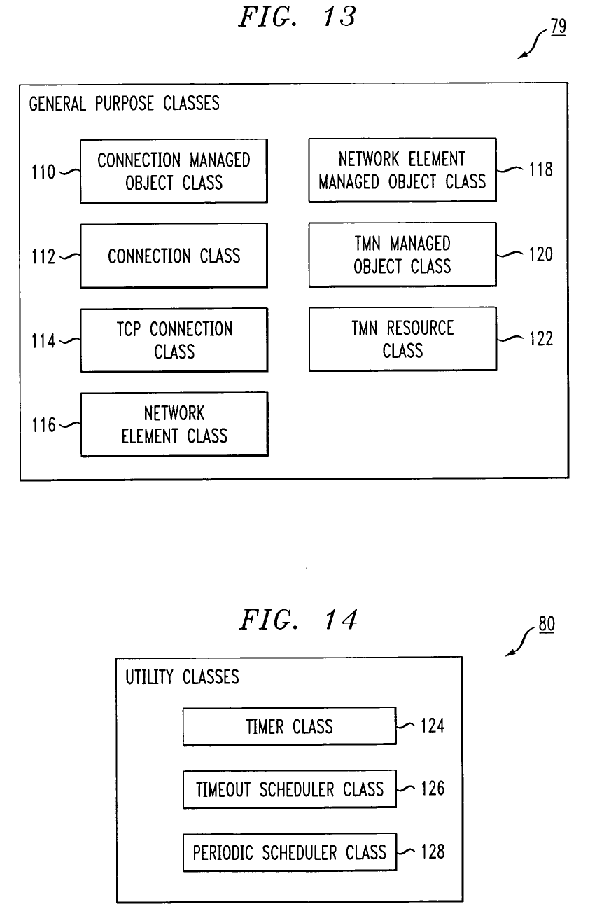

With reference to FIG. 14, the utility classes 80 include a timer class 124, a timeout scheduler class 126, and periodic scheduler class 128. The utility classes 80 are used within various frameworks, including the MOF, of the RAC framework.

With reference to FIG. 15, the interface classes 82 include attribute server interface (ASI) classes 130, MOF notifier interface classes 132, name server interface classes 134, and server map classes 136. The ASI classes 130 define MOF operations that may be performed on the managed objects. For example, ASI classes 130 support the following management operations: 1) getattributes, 2) scopedgetattributes, 3) getfirst, 4) getnext, 5) setattributes, 6) createmanagedobject, 7) deletemanagedobject, and 8) action. The getattributes operation retrieves attributes from a given managed object instance. The scopedgetattributes operation retrieves attributes from multiple managed object instances. The getfirst operation retrieves attributes from the first instance of a given managed object class. The getnext operation retrieves attributes from the next instance of the given managed object instance. The setattributes: operation modifies attributes of a given managed object instance. The createmanagedobject operation creates a new instance of a given managed object. The deletemanagedobject operation deletes the specified instance of a given managed object. The action operation specifies an operation to be performed upon specified managed objects.

A data server can forward an MOF request (i.e., set, create, delete, and action) for a given managed object to a set of registered servers using the MOF notifier interface classes 132. This is useful when the application wants to know of any changes that have been made to the database. A server can register for any combination of operations, such as set, create, delete, or action commands, as well as for a managed object instance, a managed object class, a managed object instance tree, and a managed object class tree. This feature is mainly intended for an agent server or a data server, but it can be implemented by any other server as well. For example, the MOF notifier interface classes 132 may support push-based notifications.

The name server interface classes 134 are a repository for the locations of managed object instances. These classes are responsible for mapping the distinguished name to the data server. The name server interface classes 134 provide distribution transparency of managed objects amongst servers. These classes should not be confused with the CORBA naming service. The name server interface classes 134 have a the global view of the management containment tree, whereas the individual data server has local knowledge of the containment tree.

The name server interface classes 134 support the following types of registration: 1) managed object instance registration, 2) managed object class registration, 3) managed object instance tree registration, and 4) managed object class tree registration. The managed object instance registration means that a given managed object instance is in a particular server. The managed object class registration means that all instances of a given managed object class are in a particular server. The managed object instance tree registration means that instances under a given managed object instance tree are in a particular server. The managed object class tree registration means that instances under a given managed object class tree are in a particular server. The multiple types of registrations simplify application development and also make corresponding searches faster.

The server map interface classes 136 provide a mechanism for retrieving object references for various RAC IDL interfaces. These classes are used, for example, if the application uses CORBA to communicate amongst its servers.

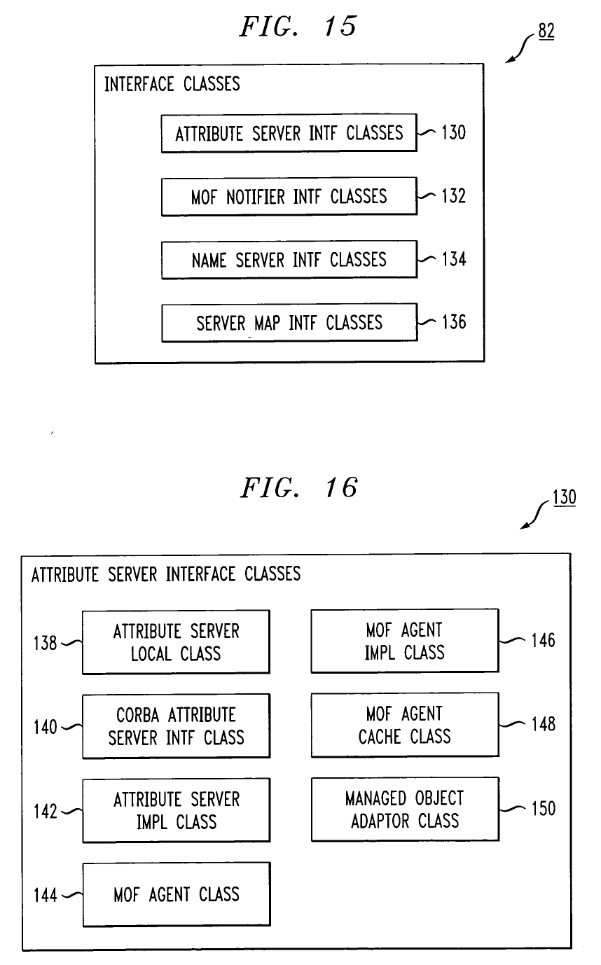

With reference to FIG. 16, the ASI classes 130 include an attribute server local class 138, a CORBA attribute server interface class 140, an attribute server implementation class 142, an MOF agent class 144, an MOF agent implementation class 146, an MOF agent cache class 148, and a managed object adaptor class 150.

The attribute server local class 138 is an implementation class of the ASI that provides a process that instantiates an instance of the class to become a data server or to receive MOF notification. The type of managed object adaptors that are installed determine the behavior of this class.

The CORBA attribute server interface class 140 implements the DA client proxy pattern and forwards ASI calls over a CORBA middleware.

The attribute server implementation class 142 implements the DA server proxy pattern. This includes receiving CORBA calls and forwarding them to a concrete ASI object.

The MOF agent class 144 serves as proxy data server. This class is capable of handling the managed object implementation distribution. A request for a given managed object may need to be split into multiple managed objects requests depending upon the schema details of the managed object def class. The MOF agent class 144 splits the managed object request into appropriate managed object requests and passes control to the MOF agent implementation class 146, which actually communicates with the data servers. The difference between the MOF agent class 144 and the MOF agent implementation class 146 is that the MOF agent class 144 uses the services of the MOF agent implementation class 146. The MOF agent class 144 finds out how the given managed object is implemented and whether it is implemented as a single managed object or multiple managed objects. Based on these findings, the MOF agent class 144 splits the given interface managed object request into multiple managed object requests. A same attribute in the interface-managed object could be in multiple implementations managed objects. For get calls, the MOF agent class 144 gets from only one server. For set, the MOF agent class 144 forwards the request to all data servers containing the attribute. For create and delete, the MOF agent class 144, forwards the request to all the servers. The MOF agent class 144 uses the managed object def class to find out the schema of managed objects as well as to understand what managed objects are implementing a given managed object. If no managed object is implementing the given managed object, the MOF agent class 144 forwards the request to MOF agent implementation class 146.

The MOF agent implementation class 146 serves as a proxy data server. This class makes use of the name server interface classes 134 to locate the data server for a given managed object class or instance and then forwards the MOF commands to the appropriate data server. The virtual functions of the MOF agent implementation class 146 use the same semantics as that of the base ASI classes.

The MOF agent cache class 148 is a sub class of the MOF agent implementation class 146 that can serve as a MOF agent as well as a data server. The MOF agent cache class 148 can be used to cache the managed objects on the agent server. This class refers to an implementation of the ASI and uses that to save the values.

The managed object adaptor class 150 is used as a factory to create and delete managed objects on any data server using MOF commands from clients. The MOF operations specific to a given managed object class are implemented by the application instead of framework. One instance of the managed object adaptor class 150 manages the MOF operations for the entire class in a given data server. Adaptors are generally used: 1) if the managed object needs to be created/deleted from the remote clients, 2) if there are large number of instances of a given managed object in the data server, the adaptor can be designed to minimize the memory usage, 3) if there is some existing code that contains the management data, the adaptor can be designed to access the data from the existing code, and 4) to improve the performance of the MOF operation.

With reference to FIG. 17, the MOF notifier interface classes 132 include an MOF notifier local class 152, a CORBA MOF notifier interface class 154, an MOF notifier implementation class 156, and an MOF notifier cache class 158.

The MOF notifier local class 152 implements the MOF notifier interface. Internally, the MOF notifier local class 152 uses four different name servers for set, create, delete, and action registrations. The name server is used to find out the affected servers whenever a given managed object is modified. All notifications are then pushed to the registered clients.

The CORBA MOF notifier interface class 154 implements the DA client proxy pattern. This class forwards MOF notifier interface calls over CORBA middleware. Clients use this to register with the remote MOF notifier local instance

The MOF notifier implementation class 156 implements the DA server proxy pattern. This class receives CORBA calls and forwards them to a concrete MOF notifier interface object.

The MOF notifier cache class 158 caches the registrations made by the given server to remote server. This may be used to recover the remote server.

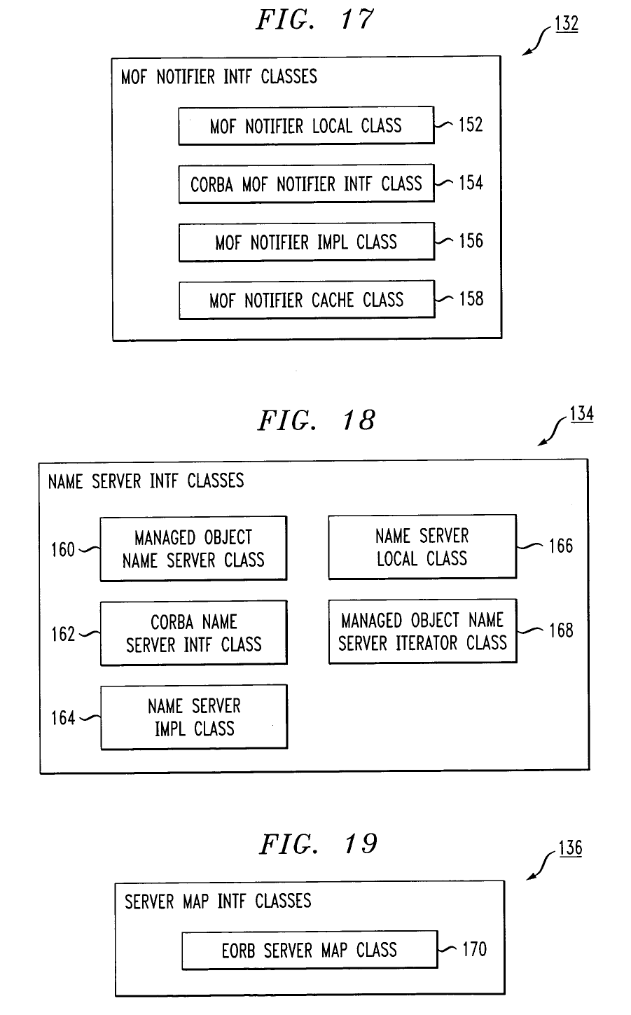

With reference to FIG. 18, the name server interface classes 134 includes a managed object name server class 160, a CORBA name server interface class 162, a name server implementation class 164, a name server local class 166, and a managed object name server iterator class 168.

The managed object name server class 160 implements the name server interface. This class maintains the internal tables that contain registration information. Clients can look up the registered information

The CORBA name server interface class 162 implements the DA client proxy pattern. This class forwards name server interface calls over CORBA middleware.

The name server implementation class 164 implements the DA server proxy pattern. This class receives CORBA calls and forwards them to a concrete name server interface object.

The name server local class 166 is used to handle failures of the name server. This class lies in the client address space and intercepts the registrations of the client. Whenever the name server fails and comes up again, an event is propagated. On receiving this event, the registrations made by the client are once again updated on the name server by the name server local class 166, thus transparently handling the failure of the name server. When the name server local class 166 is used, the name server does not have to store all the registration information in persistent storage.

The managed object name server iterator class 168 helps to iterate the registrations with the name server in lexicographical order. This class is used by the MOF agent to find the next instance of a given managed object.

With reference to FIG. 19, the server map interface classes 136 includes an EORB server map class 170. The EORB server map class 170 retrieves object-references using flat files. This class may be used only in conjunction with applications to demonstrate the capabilities of the RAC development environment.

Developers may need to deal with generated classes when building servers using MOF programming. The use cases below show how the MOF base classes can be used to perform certain tasks.

Given a managed object, the programming code below shows a number of actions declared in conjunction with the managed object:

```
DMFTestMoDefns::createManagedObjectDefs( );
ManagedObjectDef* MoDef = ManagedObjectDef::getMoDef(
“DMFTest.Resource5”);
ManagedObjectDef::ActionDefList& AllActionList = MoDef-
>getAllActionDefList( );
ManagedObjectDef::ActionDefList& ActionList1 = MoDef-
>getActionDefList( );
ManagedObjectDef::ActionDefList::iterator actItr;
ManagedObjectDef::ActionDefList::iterator actItr1;
cout << “Entering action list loop”<<endl;
cout << “Total number of actions ” <<
AllActionList.size( )<<endl;
for(actItr=AllActionList.begin( );actItr!=AllActionList.end
( );++actItr)
{
  ActionDef* actDef = *actItr;
  cout <<“ action def ”<< actDef->getName( ) << endl;
}
cout << “Number of actions in only derived class” <<
ActionList1.size( )<<endl;
for(actItr1=ActionList1.begin( );actItr1!=ActionList1.end(
);++actItr1)
{
  ActionDef* actDef = *actItr1;
  cout << “action def ”<< actDef->getName( ) << endl;
}
```

The programming code below constructs a distinguished name and creates an instance value. This method can be used while getting values from ASI.

DistinguishedName dn;
IntegerAttribute bscDynamicAttribute( “BscDynamic” ,
(int) 1);
dn.addName(“BscDynamic”, &bscDynamicAttribute);
IntegerAttribute btsDynamicAttribute( “BtsDynamic” ,
(int) 0);
dn.addName(“BtsDynamic”, &btsDynamicAttribute);

The programming code below iterates though an attribute list. The attribute list is derived from std::vector and is defined <Attribute*>. Developers can use stl style operations on the attribute list as well.

```
AttributeList::iterator listItr;
while (listItr != attlList.end( ));
{
    //do something.
    ++listItr;
}
```

The programming code below uses the attribute list.

AttributeList attrList(1);
//AttibuteList will assume ownership of attributes
inserted into list, default is not to assume ownership
IntegerAttribute* attr1 = new IntegerAttribute(“int1”,5);
DisplayStringAttribute* attr2 =
new DisplayStringAttribute(“textc”,“This is a
DisplayString attribute”);
IpAddressAttribute* attr3= new IpAddressAttribute
(“addr3”,“123.123.111.111”);
alist.add(attr1);
alist.add(attr2);
alist.add(attr3);

The programming code below adds support of push-based MOF notification to the data server. The RAC framework provides an IDL called “MofNotifier” to do the MOF notification. The data server needs to create and register the object reference of the “MofNotifier” IDL implementation class MofNotifierImpl. The following code is added to the data server:

```
...
#include “mof/MofNotifierImpl.h”
#include “mof/MofNotifierLocal.h”
#include “mof/EorbServerMap.h”
#include “mof/CorbaAttributeServerInterface.h”
#include “da/ServiceProxyFactory.h”
...
// Install proxy for the AttributeServerInterface, for
which we will use CorbaAttributeServerInterface class to
connect to the Data Client for MOF notification.
ServiceProxyFactory< CorbaAttributeServerInterface,
    AttributeServerInterface > dataClientInterface(
“DataClient”,
    (void*)“DataClient”, “DataClient”, 0);
main(int argc, char** argv)
{
    ...
    // Creating ServerMap instance
    ServerMap::instance( new EorbServerMap( ) );
    ...
    RUBY_TRY {
        ...
        // Create object reference of AttributeServer IDL
implementation
        POA_MofNotifier_tie< MofNotifierImpl >* notifier
=
            RUBY_CORBA_NEW POA_MofNotifier_tie<
MofNotifierImpl >(
                new MofNotifierImpl(
MofNotifierLocal::instance( ) ) );
        // Register object reference of MofNotifier with
POA
        if ( RubyPoaSpecific::registerObjRefWithPoa(
            notifier, serverNameId, “MofNotifier” ) == 0
)
        {
            cerr << “Failed to register MofNotifier obj
ref with POA” << endl;
            return −1;
        }
    ...
    }
    ...
}
```

Note that the server map is added above because the MOF notification uses ASI to send out the notification and that the data server needs to know the object references of the attribute server implementation of the data clients that register for the MOF notification.

The programming code below adds support of data client registering for push-based MOF notification. Any data client can register for the push-based MOF notification. The following code is added to the data client (e.g., agent server).

```
#include “mof/CorbaMofNotifierInterface.h”
#include “mof/AttributeServerImpl.h”
#include “mof/GenericManagedObjectAdaptor.h”
...
#include “THAttrDefns.h”
...
// Install proxy for MofNotifierInterface
ServiceProxyFactory< CorbaMofNotifierInterface,
    MofNotifierInterface > dataServerInterface1 (
“DataServer”,
    (void*)“DataServer”, “DataServer”, 0);
...
main( int argc, char** argv )
{
    ...
    // Create a generic managed object adaptor to handle
MOF notification. The adaptor supports create and delete
of transient MOs in memory.
    GenericManagedObjectAdaptor<THSimpleMO>* s1Adaptor =
new
        GenericManagedObjectAdaptor<THSimpleMO>(
            THAttrDefns::Simple::getFullClassName( ));
    ...
    RUBY_TRY {
        ...
        // Create object reference of AttributeServer IDL
implementation
        POA_AttributeServer_tie< AttributeServerImpl >*
server =
            RUBY_CORBA_NEW POA_AttributeServer_tie<
                AttributeServerImpl >( new
AttributeServerImpl( ) );
        // Register object reference with POA
        if( RubyPoaSpecific::registerObjRefWithPoa(
            server, serverNameId, “AttributeServer” )) ==
0 )
        {
            cerr << “Failed to register AttributeServer
obj ref with POA” << endl;
            return −1;
        }
        // Get the MofNotifierInterface handle to the
Data Server
        MofNotifierInterface* ds =
ProxyFinder<MofNotifierInterface>::
            GetProxy( “DataServer”, “DataServer”, 0 );
        if ( ds == 0 ) {
            cerr << “Cannot get MofNotifierInterface
handle to the Data Server” << endl;
            return −1;
        }
        // Register for MOF/push based notification with
the Data Server
        ds->registerForClass(
THAttrDefns::Simple::getFullclassName( ),
            serverNameId,
            MofNotifierInterface::Push,
            MofNotifierInterface::MofAll);
        ...
    }
    ...
}
```

Note a generic managed object adaptor is installed to handle receipt of MOF notification. This adaptor supports creation and deletion of transient managed objects in memory. Application can create their own specialized managed object adaptor inherited from the managed object adaptor class to handle the MOF notification.

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

We claim:

1. A method of developing one or more application programs that cooperate to manage a distributed system comprising one or more servers, wherein at least one application program is associated with each server, the method including the steps:
a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system;
b) parsing the one or more resource definition language files to ensure conformity with the object-oriented resource definition language and creating an intermediate representation of the distributed system from the one or more conforming resource definition language files;
c) processing the intermediate representation of the distributed system to form one or more programming language classes, one or more database definition files, and one or more script files;
d) providing a reusable asset center framework to facilitate development of the one or more application programs, the reusable asset center including a managed object framework that provides management functionality to the one or more application programs to support requests communicated to the distributed system from a network management station to selectively manage the one or more managed objects; and
e) building the one or more application programs from at least the one or more programming language classes, one or more database definition files, one or more script files, and the reusable asset framework.

2. The method as set forth in claim 1 wherein the distributed system is a network.

3. The method as set forth in claim 2 wherein the network is a telecommunication network.

4. The method as set forth in claim 1 wherein the managed object framework includes resource classes and interface classes.

5. The method as set forth in claim 4 wherein the resource classes include a managed object class and at least one of an attribute class, a distinguished name class, a managed object class list class, an attribute factory class, an attribute list class, an attribute iterator class, an action def class, a managed object def class, an attribute event handler class, an attribute event handlers list class, a containment tree node class, and a managed object containment tree class.

6. The method as set forth in claim 4 wherein the managed object framework also includes general purpose classes.

7. The method as set forth in claim 6 wherein the general purpose classes include at least one of a connection managed object class, a connection class, a TCP connection class, a network element class, a network element managed object class, a TMN managed object class, and a TMN resource class.

8. The method as set forth in claim 4 wherein the managed object framework also includes utility classes.

9. The method as set forth in claim 8 wherein the utility classes include at least one of a timer class, a timeout scheduler class, and a periodic scheduler class.

10. The method as set forth in claim 4 wherein the interface classes include at least one of attribute server interface classes, MOF notifier interface classes, name server interface classes, and server map interface classes.

11. The method as set forth in claim 10 wherein the attribute server interface classes include at least one of an attribute server local class, a CORBA attribute server interface class, an attribute server implementation class, an MOF agent class, an MOF agent implementation class, an MOF agent cache class, and a managed object adaptor class.

12. The method as set forth in claim 10 wherein the MOF notifier interface classes include at least one of an MOF notifier local class, a CORBA MOF notifier interface class, an MOF notifier implementation class, and an MOF notifier cache class.

13. The method as set forth in claim 10 wherein the name server interface classes include at least one of a managed object name server class, a CORBA name server interface class, a name server implementation class, a name server local class, and a managed object name server iterator class.

14. The method as set forth in claim 10 wherein the server map interface classes include an EORB server map class.

15. A method of developing one or more application programs in operative communication to manage a network including one or more servers, wherein at least one application program is associated with each server, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network created in the parsing step includes a parse tree;
c) processing the parse tree to form one or more programming language classes, wherein the one or more programming language classes formed include at least one of one or more system classes, one or more module classes, one or more managed object classes, and one or more composite attribute classes;
d) providing a reusable asset center framework to facilitate development of the one or more application programs, the reusable asset center including a managed object framework that provides management functionality to the one or more application programs to support commands communicated to the distributed system from a network management station to selectively manage the one or more managed objects; and
e) building the one or more application programs from at least the one or more programming language classes and the reusable asset framework.

16. The method as set forth in claim 15 wherein the managed object framework includes resource classes and interface classes.

17. The method as set forth in claim 16 wherein the managed object framework also includes at least one of general purpose classes and utility classes.

18. The method as set forth in claim 15 wherein the one or more resource definition language files are prepared in accordance with the object-oriented resource definition language and include a module declaration.

19. The method as set forth in claim 18 wherein the module declaration in each of the one or more resource definition language files includes at least one of an attribute type definition declaration, an enum type definition declaration, a managed object class declaration, and another module declaration.

20. The method as set forth in claim 19 wherein at least one of the one or more resource definition language files includes a module declaration and a managed object class declaration, the managed object class declaration further including an index specification and an attribute declaration.

21. The method as set forth in claim 15 wherein the resource definition language reserves at least one of a “module” keyword, a “class” keyword, an “AttributeType” keyword, an “index” keyword, a “const” keyword, a “Valid” keyword, a “readonly” keyword, an “extends” keyword, an “implements” keyword, an “enum” keyword, an “action” keyword, an “in” keyword, and an “out” keyword.

22. The method as set forth in claim 15 wherein the resource definition language reserves an “index” keyword and an “index” declaration specifies one or more attribute declarations, wherein the one or more attribute declarations include at least one attribute declaration that specifies a child relationship from an associated managed object to another managed object.

23. The method as set forth in claim 15 wherein the resource definition language reserves an “extends” keyword and an “extends” declaration is associated with a first managed object and specifies another managed object that is inherited by the first managed object.

24. The method as set forth in claim 15 wherein the resource definition language reserves an “implements” keyword and an “implements” declaration is associated with a first managed object and specifies another managed object of which the first managed object is an implementation.

25. The method as set forth in claim 15 wherein the managed object framework supports at least one of a first command to create a managed object, a second command to delete a selected managed object, a third command to retrieve one or more attributes associated with a selected managed object, a fourth command to set one or more attributes associated with a selected managed object, a fifth command to modify one or more attributes associated with a selected managed object, and a sixth command to retrieve attributes associated with one or more managed objects.

26. The method as set forth in claim 15 wherein the managed object framework allows the one or more application programs to define, model, and distribute the one or more managed objects across the one or more servers.

27. The method as set forth in claim 26 wherein the managed object framework isolates the distribution of the one or more managed objects across the one or more servers using a managed object name service.

28. A method of developing an application program to manage a network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network includes object meta-data;
c) processing the object meta-data to form one or more programming language classes, one or more database definition files, and one or more script files, wherein the one or more programming language classes formed include at least one of an index class and a query class;
d) providing a reusable asset center framework to facilitate development of the application program, the reusable asset center including a managed object framework that provides management functionality to the one or more application programs to support commands communicated to the distributed system from a network management station to manage the one or more managed objects; and
e) building the application program from at least the one or more programming language classes, one or more database definition files, one or more script files, and the reusable asset framework.

29. The method as set forth in claim 28 wherein the managed object framework includes resource classes and interface classes.

30. The method as set forth in claim 29 wherein the managed object framework also includes at least one of general purpose classes and utility classes.

31. The method as set forth in claim 28 wherein the managed object framework identifies the one or more managed objects by at least one of a managed object class name and a distinguished name hierarchy name.

32. The method as set forth in claim 28 wherein the managed object framework supports at least one of a “get” command, a “getfirst” command, a “getnext” command, a “set” command, a “create” command, a “delete” command, an “action” command, a “scope/bulk get” command, and a “processmofcommandlist” command from the network management station.

33. The method as set forth in claim 28 wherein the managed object framework supports value-based attributes, reference-based attributes, and function-based attributes associated with the one or more managed objects in conjunction with the commands communicated by the network management station.
